(19) United States
(12) Patent Application Publication
(10) Pub. No.: US 2026/0088215 A1
(43) Pub. Date: Mar. 26, 2026

(54) TRANSFORMER

(71) Applicant: KABUSHIKI KAISHA TOYOTA JIDOSHOKKI, Aichi (JP)

(72) Inventors: Kenichi NAGAYOSHI, Aichi (JP); Naoki IWATA, Aichi (JP)

(73) Assignee: KABUSHIKI KAISHA TOYOTA JIDOSHOKKI, Aichi (JP)

(21) Appl. No.: 19/325,704

(22) Filed: Sep. 11, 2025

(30) Foreign Application Priority Data
Sep. 24, 2024 (JP) 2024-164961

(51) Int. Cl. H01F 27/34; H01F 3/14; H01F 19/00; H01F 27/28

(52) U.S. Cl. CPC H01F 27/346; H01F 3/14; H01F 19/00; H01F 27/2847; H01F 2027/348

(57) ABSTRACT

A transformer includes a core having a center leg portion extending in a first direction, a side leg portion extending in the first direction and provided away from the center leg portion in a second direction, and a coupling portion connecting the center leg portion to the side leg portion, a primary winding wound around the center leg portion, a secondary winding wound around the center leg portion, and a path core forming a magnetic path, extending in the second direction, and being provided between the primary winding and the secondary winding. A gap is formed in the path core and located, as viewed in the first direction, between an inner edge of the primary winding and an outer edge of the primary winding in the second direction.

### CROSS-REFERENCE TO RELATED APPLICATION

This application claims priority to Japanese Patent Application No. 2024-164961 filed on Sep. 24, 2024, the entire disclosure of which is incorporated herein by reference.

### BACKGROUND ART

The present disclosure relates to a transformer.

There is known a transformer that includes a path core for leakage of magnetic flux, the path core being provided between a primary winding and a secondary winding (for example, see Japanese Patent Application Publication No. S59-047722). In the transformer described in the Publication, two E-shaped cores facing each other each have a center leg portion and two side leg portions, and the path core extends from a position between the center leg portions of the two E-shaped cores toward the opposite side leg portions of one of the E-shaped cores. Each of the E-shaped cores has a coupling portion that connects the center leg portion to the side leg portions.

In the transformer described in the Publication, most of leakage magnetic flux generated by a current flowing through one winding passes through a main magnetic path starting from the center leg portion through the path core, each of the side leg portions, and a corresponding one of the coupling portions back to the center leg portion in this order. However, some of the leakage magnetic flux does not pass through the center leg portion or the side leg portion but pass through a space between the path core and the coupling portion. When passing from the coupling portion toward the path core, such leakage magnetic flux may turn away from the center leg portion or the side leg portion as it approaches the path core. Similarly, when passing from the path core to the coupling portion, the leakage magnetic flux passing through the space between the path core and the coupling portion may turn toward the center leg portion or the side leg portion as it leaves away from the path core. As a result, the leakage magnetic flux may cross the winding, which generates an eddy current loss.

The present disclosure will describe a transformer in which an eddy current loss is reduced.

### SUMMARY

In accordance with an aspect of the present disclosure, there is provided a transformer that includes a core having a center leg portion extending in a first direction, a side leg portion extending in the first direction and provided away from the center leg portion in a second direction that intersects with the first direction, and a coupling portion connecting the center leg portion to the side leg portion, a primary winding wound around the center leg portion, a secondary winding provided away from the primary winding in the first direction and wound around the center leg portion, and a path core forming, together with the core, a magnetic path through which leakage magnetic flux passes, the path core extending in the second direction and being provided between the primary winding and the secondary winding. A gap is formed in the path core and located, as viewed in the first direction, between an inner edge of the primary winding and an outer edge of the primary winding in the second direction.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a perspective view illustrating a schematic configuration of a transformer according to an embodiment;

FIG. 2 is a cross-sectional view taken along a line II-II in FIG. 1;

FIG. 3 is a view schematically illustrating paths of leakage magnetic flux in the transformer illustrated in FIG. 1; and

FIG. 4 is a view schematically illustrating paths of leakage magnetic flux in a transformer according to a comparative example.

### DETAILED DESCRIPTION OF THE EMBODIMENTS

The following will describe a transformer according to an embodiment with reference to the accompanying drawings. In the description of the drawings, identical or substantially identical components have the same reference numerals, and are not reiterated. An XYZ coordinate system may be illustrated in the drawings. A Y-axis direction is a direction that intersects with (e.g., is perpendicular to) an X-axis direction (second direction) and a Z-axis direction (first direction). The Z-axis direction is a direction that intersects with (e.g., is perpendicular to) the X-axis direction and the Y-axis direction. In the following description, as one example, the X-axis direction is defined as a left-right direction (width direction), the Y-axis direction is defined as a front-rear direction (depth direction), and the Z-direction is defined as an up-down direction (height direction). The X-axis direction, the Y-axis direction, and the Z-axis direction are not limited to the above-described directions.

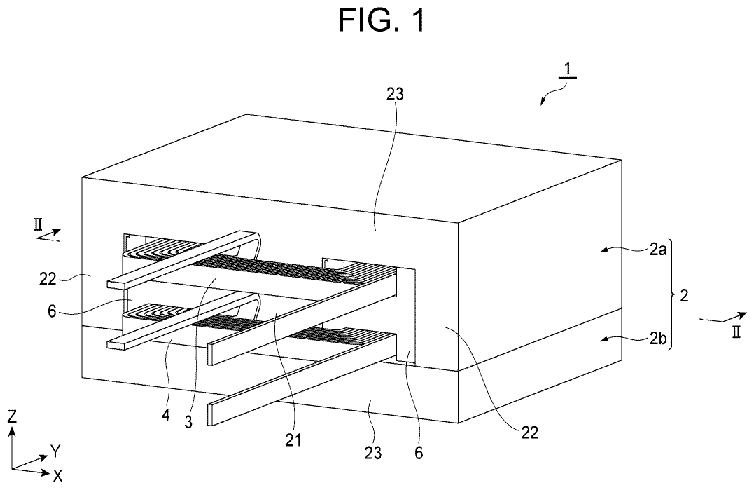

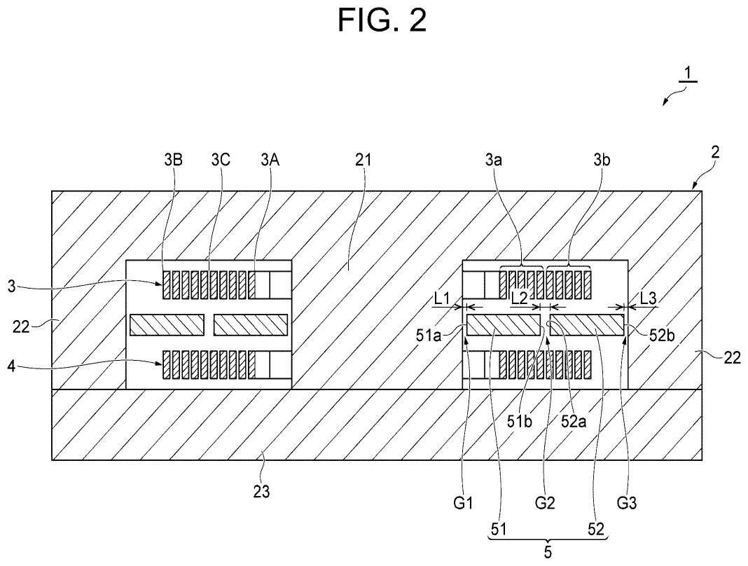

The following will describe a schematic configuration of the transformer according to the embodiment with reference to FIGS. 1 and 2. FIG. 1 is a perspective view illustrating the schematic configuration of the transformer according to the embodiment. FIG. 2 is a cross-sectional view taken along a line II-II in FIG. 1. A transformer 1 illustrated in FIGS. 1 and 2 is a device that changes voltage levels from a primary voltage to a secondary voltage and includes a core 2, a primary winding 3, and a secondary winding 4, path cores 5, and bobbins 6. Note that illustrations of the bobbins 6 are omitted in FIG. 2.

The core 2 is a magnetic body that forms magnetic paths. The core 2 includes a center leg portion 21, a pair of side leg portions 22, and a pair of coupling portions 23. The center leg portion 21 and the pair of the side leg portions 22 each extend in the up-down direction. The center leg portion 21 and the pair of the side leg portions 22 are arranged in substantially in parallel to each other. The pair of the side leg portions 22 is provided away from the center leg portion 21 on opposite sides thereof in the left-right direction. That is, in the left-right direction, the center leg portion 21 is interposed between the pair of the side leg portions 22. The pair of the coupling portions 23 is portions that connect the pair of the side leg portions 22 to the center leg portion 21. The coupling portions 23 each have a flat plate shape. One of the coupling portions 23 connects one end of the center leg portion 21 to one end of each of the side leg portions 22. The other of the coupling portions 23 connects the other end of the center leg portion 21 to the other end of each of the side leg portions 22.

In the present embodiment, the core 2 is an EI-core formed of an E-shaped core member 2a and an I-shaped core member 2b; however, the shape of the core 2 is not limited thereto. The core 2 may be an EE-core or a PQ-core.

The primary winding 3 and secondary winding 4 are coil components each formed by winding a band-shaped flat wire in a spiral shape. The flat wire is formed of a conductive member (e.g., copper) having a rectangular-shaped cross-section intersecting with (e.g., perpendicular to) a direction in which the flat wire extends and an insulating film covering a surface of the conductive member. The primary winding 3 and the secondary winding 4 are flatwise coils each formed by winding the flat wire while bending the flat wire in a thickness direction of the flat wire. The thickness direction of the flat wire is a direction along short sides of the cross-section intersecting with (for example, perpendicular to) the direction in which the flat wire extends. The primary winding 3 and the secondary winding 4 are wound around the center leg portion 21. The secondary winding 4 is provided away from the primary winding 3 in the up-down direction.

Each of the primary winding 3 and the secondary winding 4 is formed by winding the flat wire with a predetermined number of turns. In the present embodiment, each of the primary winding 3 and the secondary winding 4 is wound with ten turns; however, the number of turns of each of the primary winding 3 and the secondary winding 4 may be changed as appropriate.

In the present embodiment, in the left-right direction, a distance between the primary winding 3 and the center leg portion 21 is substantially equal to a distance between the primary winding 3 and each of the side leg portions 22. Similarly, in the left-right direction, a distance between the secondary winding 4 and the center leg portion 21 is substantially equal to a distance between the secondary winding 4 and each of the side leg portions 22. In the left-right direction, the distance between the primary winding 3 and the center leg portion 21 may be longer or shorter than the distance between the primary winding 3 and each of the side leg portions 22. Similarly, in the left-right direction, the distance between the secondary winding 4 and the center leg portion 21 may be longer or shorter than the distance between the secondary winding 4 and each of the side leg portions 22.

As illustrated in FIG. 2, the primary winding 3 of the transformer 1 has a plurality of layers stacked in the left-right direction. One of the layers corresponds to a single turn of the flat wire wound around the center leg portion 21. As described above, the cross-section of the conductive member forming the primary winding 3, which intersects with the direction in which the flat wire extends, has the rectangular shape. An outer border of the cross-section has sides extending straight in one direction and sides extending straight in a direction perpendicular to the one direction. The primary winding 3 is formed by winding the flat wire in the spiral shape so that the one sides of the cross section are in parallel to the up-down direction. There is a gap extending in the up-down direction between two adjacent turns of the conductive member of the flat wire. There is the insulating film or an air layer in the gap, for example.

In the following description, of the plurality of the layers in the primary winding 3, a plurality of the layers located close to the center leg portion 21 than the gap G2 is referred to as inner side layers 3a and a plurality of layers located away from the center leg portion 21 than the gap G2 is referred to as outer side layers 3b, for ease of explanation. The inner side layers 3a adjacent to each other defines one gap. The outer side layers 3b adjacent to each other defines one gap.

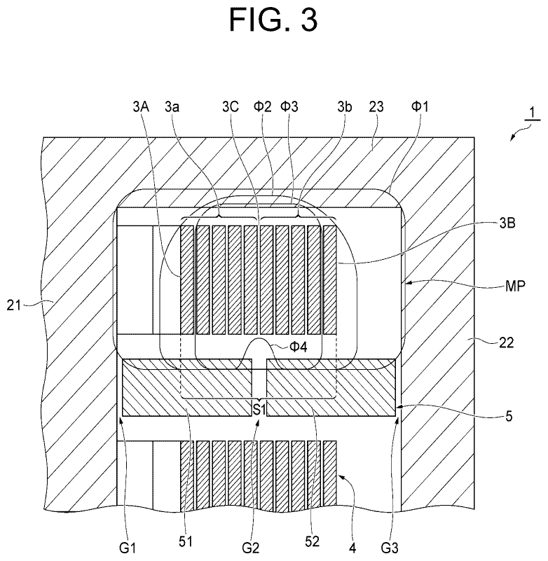

Each of the path cores 5 is a magnetic body that forms, together with the core 2, a magnetic path MP (see FIG. 3) through which leakage magnetic flux passes. The path cores 5 extend in the left-right direction and are provided between the primary winding 3 and the secondary winding 4 in the up-down direction. Each of the path cores 5 is disposed so that a plurality of gaps is formed between the center leg portion 21 and a corresponding one of the side leg portions 22. Note that each gap is a portion of the magnetic path MP in which there is no magnetic body. In the present embodiment, there is an air layer or a part of one of the bobbins 6 in each gap.

Although there are two path cores 5 in the present embodiment, the following description will focus on only one of the two path cores 5 and the surrounding configuration of the path core 5 for ease of explanation.

More specifically, the path core 5 includes a plurality of segments between the center leg portion 21 and the side leg portion 22. The plurality of the segments is arranged away from each other in the left-right direction. In the present embodiment, the path core 5 has two segments (segments 51, 52) between the center leg portion 21 and the side leg portion 22. The two segments are arranged in order of the segment 51 (first segment) and the segment 52 (second segment) from the center leg portion 21 toward the side leg portion 22. The segments 51, 52 extend in the left-right direction. A length of the segment 51 may be equal to a length of the segment 52 in the left-right direction.

A gap G1 is formed between the segment 51 and the center leg portion 21. A gap G2 is formed between the segment 51 and the segment 52. A gap G3 is formed between the segment 52 and the side leg portion 22. In other words, the plurality of the gaps formed between the center leg portion 21 and the side leg portion 22 includes the gap G1, the gap G2, and the gap G3. The gap G1 is closest to the center leg portion 21 among the plurality of the gaps. The gap G3 is closest to the side leg portion 22 among the plurality of the gaps. The gap G2 is formed between the gap G1 and the gap G3 in the left-right direction.

In the present embodiment, a length (gap length L1) of the gap G1 is substantially equal to a length (gap length L3) of the gap G3 in the left-right direction. A length of the gap G2 (gap length L2) is longer than either of the gap length L1 or the gap length L3 in the left-right direction. The gap length L1, the gap length L2, and the gap length L3 may be equal to each other. A leakage inductance of the transformer 1 depends on a sum of the lengths (gap lengths) along the magnetic path MP in the gaps formed on the magnetic path MP. Accordingly, the gap length of each gap formed between the center leg portion 21 and the side leg portion 22 is determined in order to obtain a desired leakage inductance.

The gap G2 is positioned within a range between an inner edge 3A of the primary winding 3 and an outer edge 3B of the primary winding 3 in the left-right direction. In other words, the gap G2 is located between the inner edge 3A and the outer edge 3B when viewed in the up-right direction. More specifically, an inner edge 51a of the segment 51 is located closer to the center leg portion 21 than the inner edge 3A, and an outer edge 51b of the segment 51 is located away from the center leg portion 21 than the inner edge 3A. An inner edge 52a of the segment 52 is located closer to the center leg portion 21 than the outer edge 3B, and an outer edge 52b of the segment 52 is located away from the center leg portion 21 than the outer edge 3B. As viewed in the up-down direction, the inner edge 3A overlaps the segment 51, and the outer edge 3B overlaps the segment 52. A midpoint 3C of the primary winding 3 is located in a center of the primary winding 3 in the left-right direction. A distance from the midpoint 3C to the inner edge 3A is equal to a distance from the midpoint 3C to the outer edge 3B in the left-right direction. As viewed in the up-down direction, the gap G2 overlaps the midpoint 3C.

The bobbins 6 are members that hold the primary winding 3 and the secondary winding 4. The bobbins 6 are each made of an insulating material. Examples of the insulating material of the bobbins 6 include resin such as plastic. The bobbins 6 electrically insulate the primary winding 3 from the secondary winding 4 and electrically insulate the primary winding 3 and the secondary winding 4 from the core 2. The path core 5 is accommodated in each of the bobbins 6. The bobbins 6 each hold the segments while fixing positions of the segments. Note that the core 2, the primary winding 3, the secondary winding 4, and the path core 5 may be held by an integrated injection mold formed by injection molding or may be held by potting, instead of the bobbins 6.

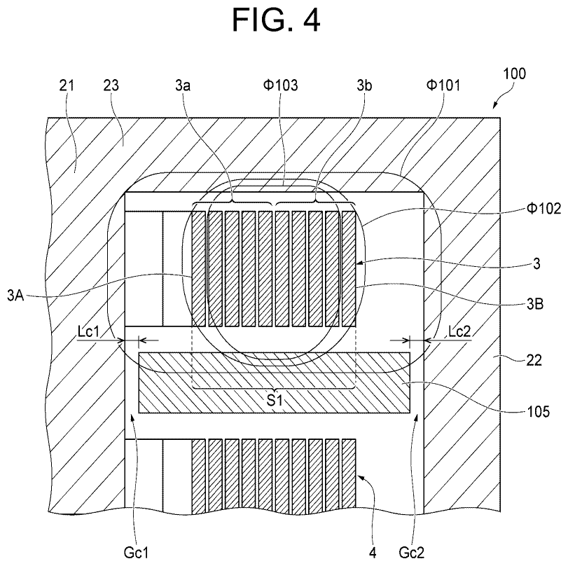

The following will describe operation and advantageous effects of the transformer 1 with reference to FIGS. 3 and 4. FIG. 3 is a view schematically illustrating the paths of the leakage magnetic flux in the transformer illustrated in FIG. 1. FIG. 4 is a view schematically illustrating paths of leakage magnetic flux in a transformer according to a comparative example. For ease of explanation, a ratio of a dimension of the transformer in the X-axis direction to a dimension of the transformer in the Z-axis direction in FIGS. 3 and 4 is different from that in FIG. 2. A transformer 100 illustrated in FIG. 4 is different from the transformer 1 mainly in that the transformer 100 includes a path core 105 instead of the path core 5.

The path core 105 is different from the path core 5 mainly in that the path core 105 is not divided into a plurality of segments. In other words, the path core 105 is formed of one magnetic body extending in the left-right direction. A gap Gc1 is formed between an inner edge of the path core 105 and the center leg portion 21, and a gap Gc2 is formed between an outer edge of the path core 105 and the side leg portion 22. A sum of a length (gap length Lc1) of the gap Gc1 in the left-right direction and a length (gap length Lc2) of the gap Gc2 in the left-right direction is substantially equal to a sum of the gap length L1, the gap length L2, and the gap length L3 in the transformer 1. Although a gap G2 is not formed in the transformer 100, for ease of explanation, layers that are located at the same positions as the inner side layers 3a in the transformer 1 are referred to as inner side layers 3a, and layers that are located at the same positions as the outer side layers 3b in the transformer 1 are referred to as outer side layers 3b.

In the transformer 100, when a current flows through the primary winding 3 in one direction, magnetic flux is generated. Here, leakage magnetic flux Φ101, which is some of the leakage magnetic flux, passes through a loop path (magnetic path) starting from the center leg portion 21 of the core 2 through the gap Gc1, the path core 105, the gap Gc2, the side leg portion 22, and the coupling portion 23 back to the center leg portion 21 in this order. When the current flows through the primary winding 3 in the opposite direction, the leakage magnetic flux Φ101 passes through a loop path starting from the center leg portion 21 of the core 2 through the coupling portion 23, the side leg portion 22, the gap Gc2, the path core 105, and the gap Gc1 back to the center leg portion 21 in this order.

The following will describe a case where a current flows through the primary winding 3 in one direction, and a description in a case where a current flows through the primary winding 3 in the opposite direction is omitted. There may be leakage magnetic flux passing through a space (air layer or bobbin 6) between the coupling portion 23 and the path core 105 without passing through the center leg portion 21 and the side leg portions 22. Such leakage magnetic flux includes leakage magnetic flux Φ102 and leakage magnetic flux Φ103. The leakage magnetic flux Φ102 passes from a loop path starting from the coupling portion 23 through a gap between the inner side layer 3a that is the most inside layer in the primary winding 3 and the center leg portion 21, the path core 105, and a gap between the outer side layer 3b that is the most outside layer in the primary winding 3 and the side leg portion 22 back to the coupling portion 23 in this order. The leakage magnetic flux Φ103 passes through a loop path starting from the coupling portion 23 through a gap between adjacent two of the inner side layers 3a, the path core 105, and a gap between adjacent two of the outer side layers 3b back to the coupling portion 23 in this order.

In the path core 105, there is no gap in a section S1 that overlaps the range between the inner edge 3A and the outer edge 3B as viewed in the up-down direction, so that a magnetic permeability is constant in the section S1. That is, a magnetic reluctance is constant in the section S1. Accordingly, the leakage magnetic flux Φ102 and the leakage magnetic flux Φ103 are distributed on opposite sides of the primary winding 3 in the left-right direction and pass into the path core 105. That is, the leakage magnetic flux Φ102 and the leakage magnetic flux Φ103 may spread over a wide range in the left-right direction. Here, as a position at which each of the leakage magnetic flux Φ102 and the leakage magnetic flux Φ103 passes into the path core 105 becomes closer to the side leg portion 22, each of the leakage magnetic flux Φ102 and the leakage magnetic flux Φ103 passes toward the magnetic core 105 so as to be further inclined relative to the up-down direction. As a result, the leakage magnetic flux Φ102 becomes increasingly likely to cross the primary winding 3 near a lower end of the inner side layer 3a that is the most inside layer in the primary winding 3. Similarly, the leakage magnetic flux Φ103 becomes increasingly likely to cross the primary winding 3 near a lower end of the inner side layer 3a that is the outer layer of the adjacent two of the inner side layers 3a defining the gap through which the leakage magnetic flux Φ103 passes. As a result, an eddy current loss may be generated.

In the transformer 1, the sum of the gap length L1, the gap length L2, and the gap length L3 is set to be substantially equal to the sum of the gap length Lc1 and the gap length Lc2 in order to obtain desired leakage magnetic flux. In the transformer 1, the leakage magnetic flux generated by the current flowing through the primary winding 3 includes leakage magnetic flux Φ1, leakage magnetic flux Φ2, and leakage magnetic flux Φ3.

In the transformer 1, when the current flows through the primary winding 3, magnetic flux is generated. Here, the leakage magnetic flux Φ1, which is some of the leakage magnetic flux, passes through a loop path (magnetic path) starting from the center leg portion 21 of the core 2 through the gap G1, the segment 51, the gap G2, the segment 52, the gap G3, the side leg portion 22, and the coupling portion 23 back to the center leg portion 21 in this order.

The leakage magnetic flux Φ2 passes through a loop path starting from the coupling portion 23 through the gap between the inner side layer 3a that is the most inside layer in the primary winding 3 and the center leg portion 21, the segment 51, the gap G2, the segment 52, and the gap between the outer side layer 3b that is the most outside layer in the primary winding 3 and the side leg portion 22 back to the coupling portion 23 in this order. The leakage magnetic flux Φ3 passes through a loop path starting from the coupling portion 23 through the gap between adjacent two of the inner side layers 3a, the segment 51, the gap G2, the segment 52, and the gap between adjacent two of the outer side layers 3b back to the coupling portion 23 in this order.

Here, a permeability of the gap G2 in the transformer 1 is lower than a permeability of the segment 51. In other words, there is a portion where a magnetic reluctance is high in the section that overlaps the range between the inner edge 3A and the outer edge 3B of the primary winding 3 as viewed in the up-down direction, in the magnetic path from the center leg portion 21 to the side leg portion 22 through the path core 5. Thus, the leakage magnetic flux Φ2 passing through the space between the coupling portion 23 and the path core 5 becomes increasingly likely to pass into the path core 5 at a position before the gap G2 without passing toward the gap G2, which is the high magnetic reluctance portion. Accordingly, it is suppressed that the path of the leakage magnetic flux Φ2 is inclined relative to the up-down direction, so that the leakage magnetic flux that crosses the primary winding 3 is reduced. As a result, it is possible to reduce the eddy current loss.

Similarly, the leakage magnetic flux Φ3 passing through the gap between the adjacent two of the inner side layers 3a becomes increasingly likely to pass into the path core 5 at a position before the gap G2 without passing toward the gap G2, which is the high magnetic reluctance portion. Accordingly, it is suppressed that the path of the leakage magnetic flux Φ3 is inclined relative to the up-down direction, so that the leakage magnetic flux that crosses the primary winding 3 is reduced. As a result, it is possible to reduce the eddy current loss.

Here, in the gap G2, there may be leakage magnetic flux Φ4 that passes closer to the primary winding 3 than the gap G2, in addition to the magnetic flux that passes straight from the segment 51 toward the segment 52. Such the leakage magnetic flux Φ4 is hardly generated in the path core 105 without a gap, whereas it may be generated in the path core 5 with the gap G2. When the leakage magnetic flux Φ4 crosses the primary winding 3, an eddy current loss is generated. However, in the transformer 1, it is avoided that the leakage magnetic flux locally crosses the primary winding 3 as in the transformer 100. Since a magnitude of an eddy current loss is proportional to a square of an amount of magnetic flux (magnetic flux density) crossing a winding, the eddy current loss in the transformer 1 is reduced as compared with that in the transformer 100.

The primary winding 3 is a flatwise coil. The flatwise coil is formed by winding a flat wire formed of a conductive member and an insulating film covering a surface of the conductive member in a spiral shape. With this configuration, there is the gap extending in the up-down direction between the two adjacent turns of the conductive member of the flat wire. The leakage magnetic flux Φ3, which is some of the leakage magnetic flux, may pass through the gap. As described above, the leakage magnetic flux Φ3 passing through the gap become also increasingly likely to pass into the path core at a position before the gap G2, so that the leakage magnetic flux crossing the primary winding may be reduced. As a result, it is possible to reduce the eddy current loss.

As viewed in the up-down direction, the gap G2 overlaps the midpoint 3C of the primary winding 3, and the distance from the inner edge 3A to the midpoint 3C is equal to the distance from the outer edge 3B to the midpoint 3C. When a direction of the voltage applied to the primary winding 3 is changed, directions of the leakage magnetic flux Φ2 and the leakage magnetic flux Φ3 passing through the space between the coupling portion 23 and the path core 5 change. Since the gap G2 overlaps the midpoint 3C as viewed in the up-down direction, the leakage magnetic flux Φ2 passing toward the path core 5 (segment 51) from the coupling portion 23 through the space between the primary winding 3 and the center leg portion 21 and the leakage magnetic flux Φ2 passing toward the path core 5 (segment 52) from the coupling portion 23 through the space between the primary winding 3 and the side leg portion 22 become both increasingly likely to pass into the path core 5 at positions before the gap G2, so that the leakage magnetic flux that crosses the primary winding 3 is reduced. In addition, the leakage magnetic flux Φ3 passing toward the path core 5 (segment 51) from the coupling portion 23 through the gap between the adjacent two of the inner side layers 3a and the leakage magnetic flux Φ3 passing toward the path core 5 (segment 52) from the coupling portion 23 through the gap between the adjacent two of the outer side layers 3b become both increasingly likely to pass into the path core 5 at positions before the gap G2, so that the leakage magnetic flux that crosses the primary winding 3 is reduced. As a result, it is possible to reduce the eddy current loss.

Leakage magnetic flux may be generated in the segment 52 and leaks from the segment 52 toward the primary winding 3, as the leakage magnetic flux Φ2 and the leakage magnetic flux Φ3. This leakage magnetic flux contains a component in the up-down direction. As described above, the leakage magnetic flux Φ4 is generated in the gap G2 and passes into the segment 52 near the gap G2. Here, the leakage magnetic flux Φ4 may intersect with some of the leakage magnetic flux leaked from the segment 52 toward the primary winding 3 to cancel out it. More specifically, the leakage magnetic flux Φ4 intersects with some of the leakage magnetic flux leaked from the segment 52 in a region close to the gap G2 in the segment 52, and the leakage magnetic flux Φ4 and the some of the leakage magnetic flux cancel out each other. As one example, the leakage magnetic flux Φ4, which is some of the leakage magnetic flux Φ2 and passes closer to the primary winding 3 than the gap G2, intersects with the leakage magnetic flux Φ3, and the leakage magnetic flux Φ4 and the leakage magnetic flux Φ3 cancel out each other. Thus, the leakage magnetic flux that crosses the primary winding 3 is reduced. As a result, it is possible to reduce the eddy current loss.

The embodiments of the present disclosure has been described in detail above; however, the transformer according to the present disclosure is not limited to the above-described embodiments.

The primary winding 3 and the secondary winding 4 may be edgewise coils. That is, the primary winding 3 and the secondary winding 4 may be formed by winding a conductive member in a spiral shape. The primary winding 3 and the secondary winding 4 may be coil components each formed by winding a wire around the center leg portion 21 in an alpha-winding manner.

As viewed in the up-down direction, the gap G2 need not overlap the midpoint 3C. For example, as viewed in the up-down direction, the gap G2 may be located between the inner edge 3A and the midpoint 3C or between the outer edge 3B and the midpoint 3C.

The path core 5 may have three or more segments. In this case, at least one of gaps formed between adjacent two of the segments is positioned between the inner edge 3A and the outer edge 3B in the left-right direction. Another gap may be positioned between the inner edge 3A and the outer edge 3B, closer to the center leg portion 21 than the inner edge 3A, or away from the center leg portion 21 than the outer edge 3B.

What is claimed is:

1. A transformer comprising:
a core having a center leg portion extending in a first direction, a side leg portion extending in the first direction and provided away from the center leg portion in a second direction that intersects with the first direction, and a coupling portion connecting the center leg portion to the side leg portion;
a primary winding wound around the center leg portion;
a secondary winding provided away from the primary winding in the first direction and wound around the center leg portion; and
a path core forming, together with the core, a magnetic path through which leakage magnetic flux passes, the path core extending in the second direction and being provided between the primary winding and the secondary winding, wherein
a gap is formed in the path core and located, as viewed in the first direction, between an inner edge of the primary winding and an outer edge of the primary winding in the second direction.

2. The transformer according to claim 1, wherein
the primary winding is a flatwise coil.

3. The transformer according to claim 1, wherein
as viewed in the first direction, the gap overlaps a midpoint of the primary winding, and a distance from the inner edge to the midpoint is equal to a distance from the outer edge to the midpoint.
